(19) United States
(12) Patent Application Publication
(10) Pub. No.: US 2003/0110156 A1
(43) Pub. Date: Jun. 12, 2003

(54) Information collecting apparatus, information collecting method and information collecting program

(76) Inventors: Takashi Iwamoto, Kawasaki (JP); Orio Ritani, Kawasaki (JP); Kazuhiro Hosoi, Kawasaki (JP); Syigeaki Honjyou, Kawasaki (JP); Yutaka Morioka, Tokyo (JP)

Correspondence Address: STAAS & HALSEY LLP, 700 11TH STREET, NW, SUITE 500, WASHINGTON, DC, 20001, US

(21) Appl. No.: 10/109,056

(22) Filed: Mar. 29, 2002

(30) Foreign Application Priority Data
Dec. 7, 2001 (JP) 2001-373714

(51) Int. Cl. G06F 7/00

(52) U.S. Cl. 707/1

(57) ABSTRACT

An information collecting apparatus, an information collecting method and an information collecting program that make it possible to collect required information speedily and easily from among a large amount of information distributed around a plurality of information sources, by matching user attributes and information source attributes.

### FIELD OF THE INVENTION

The present invention relates to a technique for collecting required information quickly and easily from among a large amount of information distributed around a plurality of information sources.

### RELATED ART OF THE INVENTION

In enterprises, enterprise internal information systems such as intranets are introduced in order to improve work efficiency and productivity. In an enterprise information system, a large amount of information to be utilized in business operations is distributed around a plurality of information sources (databases) for storage.

However, since the amount of information is so large, it is hard to ascertain how information are managed in each of the information sources, and it is therefore difficult to manage the information. Furthermore, with regard to any given information, since master information being source information, and copy information which is obtained by copying the master information, are mixedly existing, and also some information becomes obsolete from day to day, accessed information is not always up-to-date. Moreover, since information is increased or updated from day to day, it is practically impossible to always ascertain it. Therefore, a great deal of time and effort must be spent in order to collect required information, and hence the enterprise internal information system is not always utilized effectively.

### SUMMARY OF THE INVENTION

The present invention takes the above conventional problems into consideration with an object of providing an information collecting technique capable of collecting required information quickly and easily from among a large amount of information distributed around a plurality of information sources, by matching user attributes and information source attributes.

To achieve the above object, an information collecting technique according to the present invention is characterized in that all information distributed around a plurality of information sources is arranged in a multi-dimensional map so as to enable to be identified according to a plurality of attributes thereof, the locations of information sources are registered, information contained in multi-dimensional regions that are delimited arbitrarily according to the plurality of attributes is selected referring to the multi-dimensional map, and, for all information selected, information is collected from the registered locations of the information sources. Here, it is desirable to register access modes for the information sources in related to the locations of the information sources, and collect information from the information sources based on the registered access modes.

In such a constitution, prior to collecting information, all information distributed around the plurality of information sources is arranged in the multi-dimensional map so as to enable to be identified according to the plurality of attributes thereof (freshness, source region, access authorization and the like), and also the locations of the information sources are registered. Then, after multi-dimensional regions that delimit information collecting ranges by the plurality of attributes of information are set, information contained in the multi-dimensional regions is selected referring to the multi-dimensional map. Since all information selected is arranged in the multi-dimensional map so as to enable to be identified, the locations of the information sources are clarified. Next, for all information selected, information is collected from the registered locations of information sources. Therefore, it is possible to collect required information quickly and easily from among a large amount of information distributed around the plurality of information sources.

Here, if information is collected from information sources based on the registered access modes, it is possible to collect required information easily even if an access mode of an information source is not ascertained.

Furthermore, the constitution may be such that multi-dimensional regions related to information users are registered, and information contained in the registered multi-dimensional regions is selected referring to the multi-dimensional map. In this manner, if multi-dimensional regions related to information users are registered once, then whenever information is required, it is possible to collect required information easily by only designating the registered multi-dimensional region.

Moreover, the constitution may be such that, when an information source cannot be accessed, alternative information for accessing to similar information is registered. In this manner, for example, even when it is outside of a permitted access time to an information source, and the required information cannot be accessed, it is possible to collect similar information.

In addition, the constitution may be such that relational information models are displayed, at least one relational model is specified from among them, and information contained in the multi-dimensional regions is selected from a range of the specified relational models. In this manner, information users can specify an information collecting range flexibly and arbitrarily, so that unnecessary information is prevented from being collected, and therefore only really required information is collected.

Moreover, the constitution may be such that, when it is outside of a permitted access time to an information source, at least the time until access is possible is displayed. In this manner, it becomes possible to ascertain the time until access is possible.

Other objects and aspects of the present invention will become apparent from the following description of embodiments, in association with appended drawings.

### BRIEF EXPLANATION OF THE DRAWINGS

FIG. 1 is a block diagram of an information collecting apparatus according to the present invention;

FIG. 2 is an explanatory diagram of information source access modes;

FIG. 3 is an explanatory diagram of relational models;

FIG. 4 is an explanatory diagram of a multi-dimensional map;

FIG. 5 is a flow chart showing processing to be executed by a client;

FIG. 6 is a flow chart showing processing to be executed by a server;

FIG. 7 shows an information selection method, in which (A) is an explanatory diagram of a multi-dimensional map and multi-dimensional regions and (B) is an explanatory diagram of a selection result;

FIG. 8 shows a project to which a local supply person belongs, in which (A) is an explanatory diagram of new supplier searching and (B) is an explanatory diagram of an investigation into parts flow amount;

FIG. 9 is an explanatory diagram of a relational model of parts flow amount;

FIG. 10 shows an example of user metainformation, in which (A) is an explanatory diagram of an employee table and (B) is an explanatory diagram of a job list table;

FIG. 11 shows an example of information source metainformation, in which (A) is an explanatory diagram of a basic attributes table and (B) is an explanatory diagram of a detailed attributes table;

FIG. 12 is an explanatory diagram of an information selection method using a multi-dimensional map;

FIG. 13 is an explanatory diagram of a screen for specifying an information collection object; and

FIG. 14 is an explanatory diagram of a display screen of collected information.

### PREFERRED EMBODIMENT

As follows is a detailed description of the present invention with reference to appended drawings.

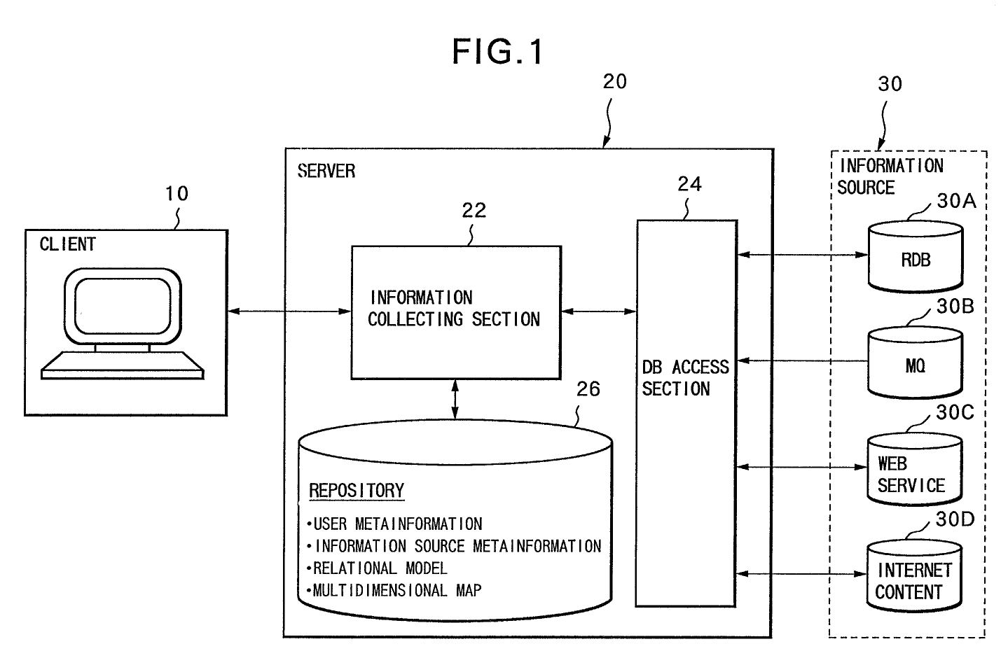

FIG. 1 shows a constitution in which an information collecting apparatus according to the present invention is constructed using a client-server system. Here, a client 10 and a server 20 are provided with at least a central processing unit (CPU) and memory, respectively, and various functions related to information collecting are realized by a program loaded into the memories.

The client 10, which is operated by a user being an information user, specifies an information collection object, and is used as a browser for displaying or printing collected information (referred to hereunder as “collection information”).

The server 20 comprises an information collecting section 22, a DB (database) access section 24 and a repository 26.

In the information collecting section 22, in response to a request for collecting information from the client 10, user attributes and information source attributes are matched (the detail is described later) and information to be collected is selected. Then, a request for collecting information is issued, with the selected information as a parameter, to the DB access section 24. When collection information is returned from the DB access section 24, it is transmitted to the client 10.

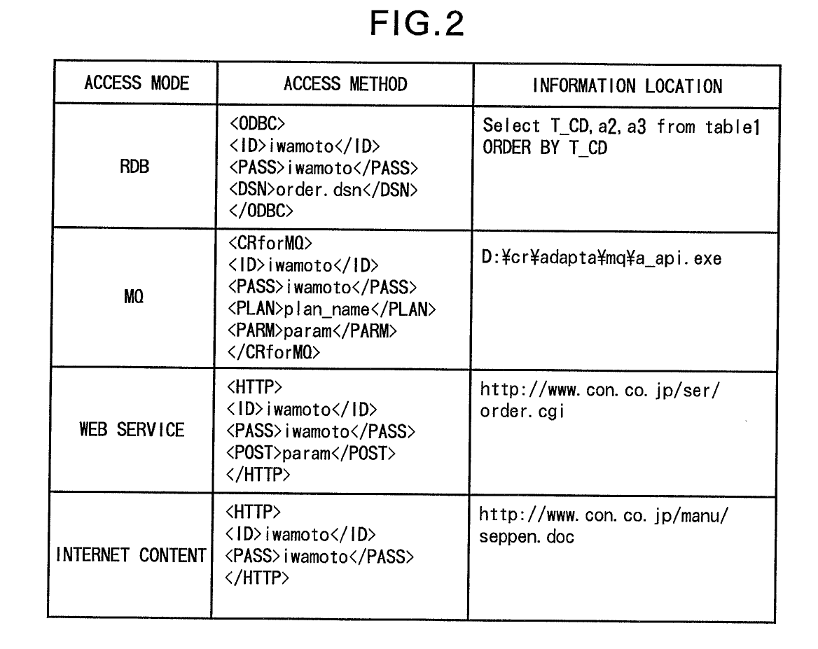

In the DB access section 24, in response to the request for collecting information from the information collecting section 22, information distributed around a plurality of information sources 30 (30A through 30D) is collected. At this time, since there may be a possibility that access modes to the plurality of information sources 30 are different, information collecting is performed via adaptors depending on the access modes. Here, the access modes to the information sources 30 include, as shown in FIG. 2, RDB (Relational Data Base), MQ (Message Queuing), Web service, Internet content, or the like. In each of the access modes, access to the information sources is performed using an access method and an information location as shown in the figure.

Here, an information selection device and information selection function are realized by the information collecting section 22, and the information collecting device and information collecting function are realized by the information collecting section 22 and the DB access section 14.

The repository 26, which is also called a data dictionary, is a database to be used by the present information collecting apparatus internally. At least user metainformation, information source metainformation, relational models, and a multi-dimensional map are registered in the repository 26. Here, a user attributes registration device and information source attributes registration device are realized by the repository 26.

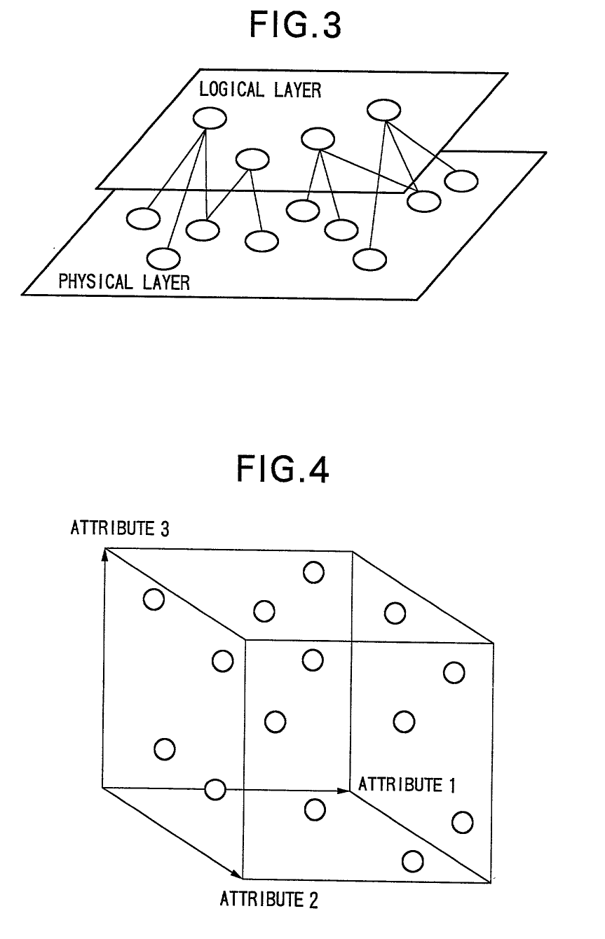

Personal specification information for specifying users and range specification information for specifying ranges of required information are set, as user attributes, in the user metainformation. Items for delimiting information collecting ranges are set in the range specification information via a plurality of attributes (information source regions, information freshness, access authorization and the like). The information source regions, information freshness, access modes, access methods, information locations, access authorization and the like, for example, are set, as attributes of each of information sources, in the information source metainformation. The relational models are data models, as shown in FIG. 3, in which respective items of information in an information source being physical layers are mapped with logical layers. The multi-dimensional map is, as shown in FIG. 4, a map in which all information is arranged multi-dimensionally and so as to enable to be identified, according to the user attributes and information source attributes. For example, in a case having attribute 1 through attribute 3, the multi-dimensional map is expressed as a three-dimensional map as shown in the figure.

Here, the user metainformation, information source metainformation, relational models and multi-dimensional map are created and updated manually by an operator or automatically, for example.

Next is a description of a basic principle of information collecting apparatus.

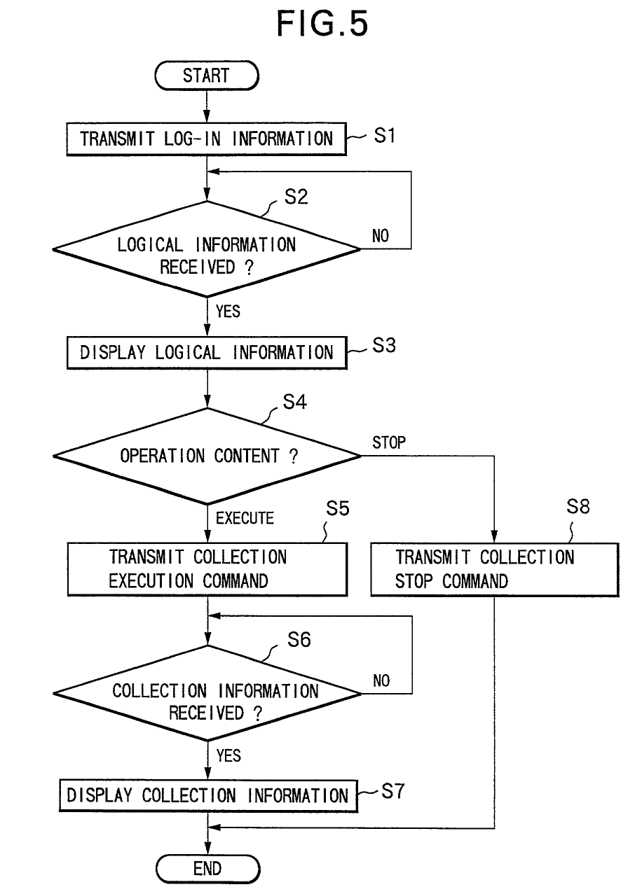

FIG. 5 shows processing content to be executed when, in the client 10, a user logs in.

In step 1 (abbreviated to “S1” in the figure, and the same hereunder), a user ID and password, being log-in information, are transmitted to the server 20.

In step 2, it is judged whether or not logical information has been received from the server 20. Here, the logical information means information of a relational model included in an information range delimited by the range specification information in the user metainformation of the user, which is specified by the log-in information. If the logical information has been received, control proceeds to step 3 (Yes), while if the logical information has not been received, control waits (No).

In step 3, the logical information received is displayed on a display device such as a display. After specifying a relational model being an information collection object, from among the displayed logical information, the user makes the information collecting apparatus to collect the information. Here, the user can stop collecting information at any time regardless of whether or not the information collection object is specified. Here, the function for displaying the logical information corresponds to a relational model display device, and the function for specifying relational models corresponds to a relational model specifying device.

In step 4, branching is performed depending on the content of the user's operation. That is to say, after the user specifies the information collection object, for example if an “execute” button is pressed to issue a collection execution command, control proceeds to step 5. On the other hand, for example if the user presses a “cancel” button to issue a collection stop command regardless of whether or note the information collection object is specified, control proceeds to step 8.

In step 5, object specification information for specifying the information collection object and a collection execution command are transmitted to the server 20.

In step 6, it is judged whether or not collection information has been received from the server 20. If the collection information has been received, control proceeds to step 7 (Yes), and the collection information is displayed on the display device. On the other hand, if the collection information has not been received, control waits (No).

In step 8, collection stop information is transmitted to the server 20 in order to stop collecting information.

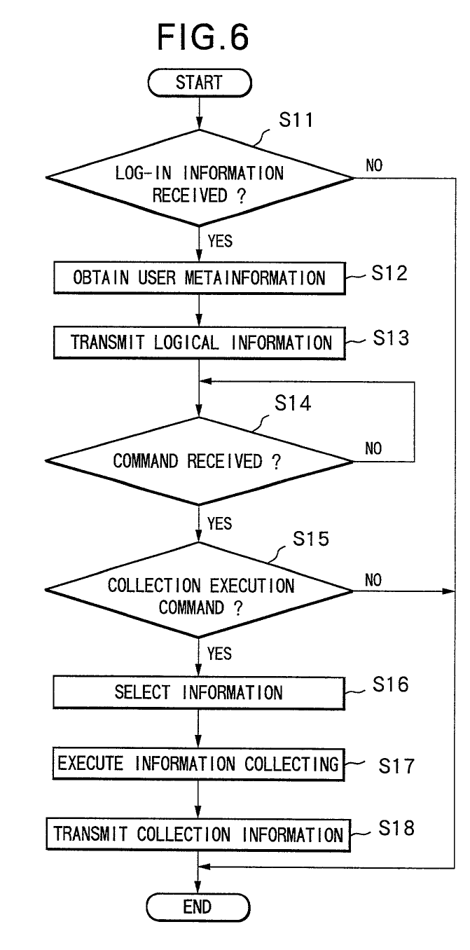

FIG. 6 shows processing content to be executed repeatedly every predetermined time period in the server 20.

In step 11, it is judged whether or not the log-in information has been received from the client 10. If the log-in information has been received, control proceeds to step 12 (Yes), while if the log-in information has not been received, control terminates (No).

In step 12, a user is specified based on the log-in information, and the user metainformation related to the user is obtained from the repository 26.

In step 13, the logical information related to the user metainformation, that is, a relational model, is obtained, and this is transmitted to the client 10.

In step 14, it is judged whether or not a command (collection execution command or collection stop command) has been received from the client 10. If the command has been received, control proceeds to step 15 (Yes), while if the command has not been received, control waits (No).

In step 15, it is judged whether or not the received command is a collection execution command. If the received command is a collection execution command, control proceeds to step 16 (Yes), while if the received command is not a collection execution command, that is, it is a collection stop command, control terminates (No).

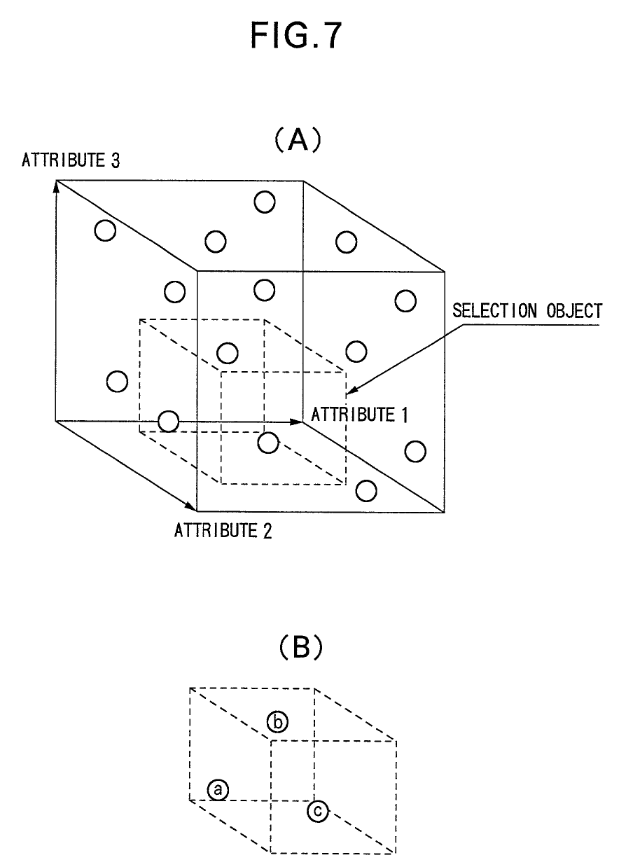

In step 16, selection of information to be collected is performed based on the object specification information transmitted together with the collection execution command. That is to say, all information distributed around the plurality of information sources 30 is arranged in a multi-dimensional map as shown in (A) of FIG. 7. On the other hand, the object specification information, as shown by broken lines in the figure, is represented as a multi-dimensional region in the multi-dimensional map with the attribute 1 through attribute 3 as parameters. Then, as shown in (B) of FIG. 7, information contained in the multi-dimensional region that is delimited by the object specification information is selected as information to be collected. The example in the figure shows the states where information “a” to information “c” are selected as information to be collected. Here, the processing in step 16 corresponds to an information selection device or an information selection function.

In step 17, the selected information content is collected from the information sources 30. That is to say, for all information selected in step 16, the information source metainformation of the repository 26 is referenced, and the access modes, access methods, information locations and the like are extracted. Then, the adaptors appropriate to the extracted access modes are automatically selected, and using the access methods, information locations and the like, the information content is collected from the information sources 30. Here, the processing in step 17 corresponds to an information collecting device and an information collecting function.

In step 18, the collection information is transmitted to the client 10.

According to the above described processing of FIG. 5 and FIG. 6, when the user logs in, the user metainformation specified by the log-in information is obtained. When the user metainformation is obtained, the logical information related thereto is obtained and displayed. If the collection execution command is issued after the information collection object has been specified, information to be collected is selected from among all information arranged in the multi-dimensional map. Then, for all information selected, the adaptors appropriate to the access modes are selected automatically, and the information content is collected from the information sources.

Therefore, if the user metainformation, information source metainformation, relational models and multi-dimensional map are created in advance, the user can collect required information quickly and easily. At this time, by displaying the relational models as the logical information, on the display device and specifying these, even if there is a plurality of logical information related to the user, it is possible to collect only the required information.

Next is a description of an operation for ascertaining an amount of parts deliveries and their unit costs in order to reduce the number of parts types, as an applied example of an information collecting apparatus according to the present invention. Here, a local supply person being a user, belongs to a parts flow amount investigation project, and collects information of local parts delivery history and unit costs.

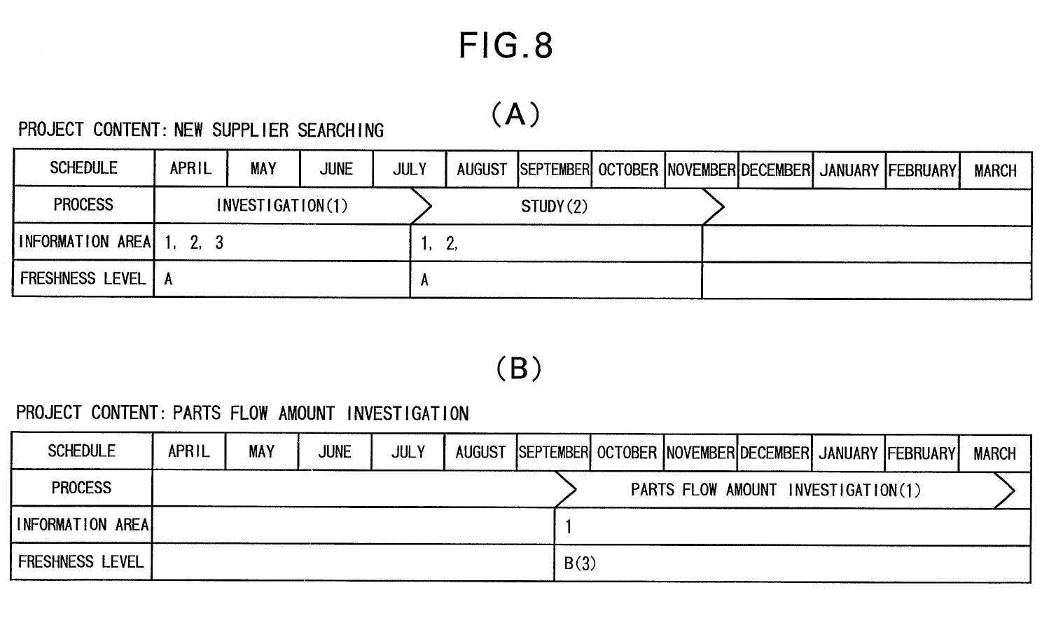

The local supply person is in charge of an operation for providing new suppliers and investigating parts flow amount in a schedule and process as shown in FIG. 8. Here, information area refers to attributes that indicate the locations of information required to achieve each project. For example, the settings may be inside own company (1), inside a group enterprise (2), and outside a company (3). Furthermore, freshness level refers to attributes that distinguish master information being information source, from copy information of the master information. For example, the settings may be master information A, and copy information B. In the case of copy information, it is desirable that the duration from when information is generated can be specified, so that the information collection objects can be specified arbitrarily and flexibly. In the example as shown in the figure, the item set to “B (3)” as the freshness level indicates that the copy information within the last three days is required.

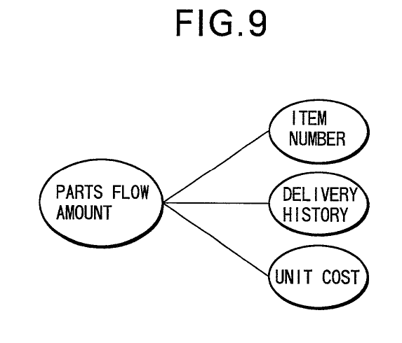

FIG. 9 shows a relational model of parts flow amount. The parts flow amount being a logical layer, is related to an item number, delivery history and unit cost, being physical layers.

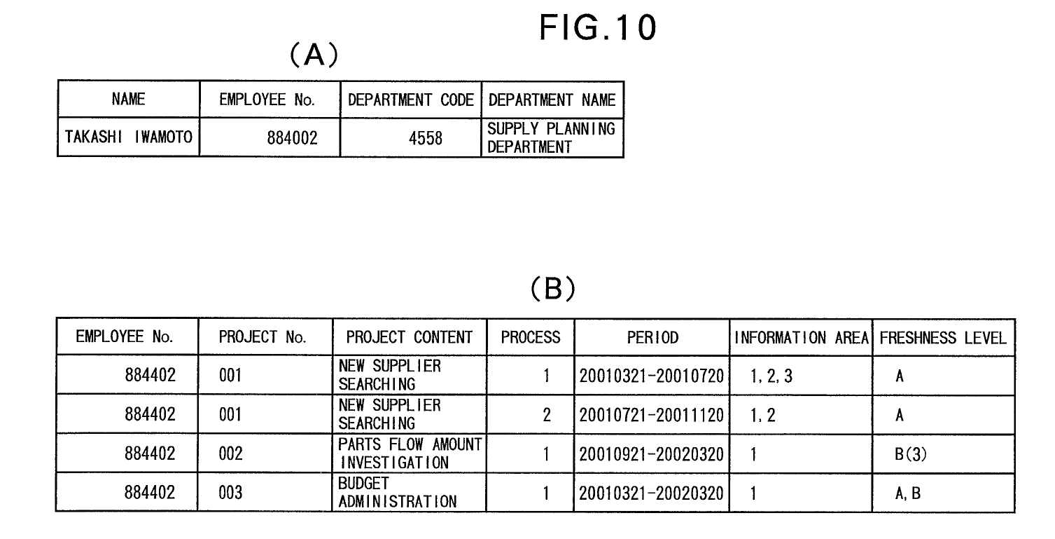

In this case, an employee table being the personal specification information, and a job list table being the range specification information, are set in the user metainformation of the repository 26 as attributes of the local supply person. As shown in (A) of FIG. 10, the personal specification information for specifying employees is set in the employee table. For example, name, employee number, department code and department name are set. Furthermore, as shown in (B) of FIG. 10, the content of each job charged by the employee is set in the job list table. For example, the employee number, project number, project content, process, period, information area and freshness level are set.

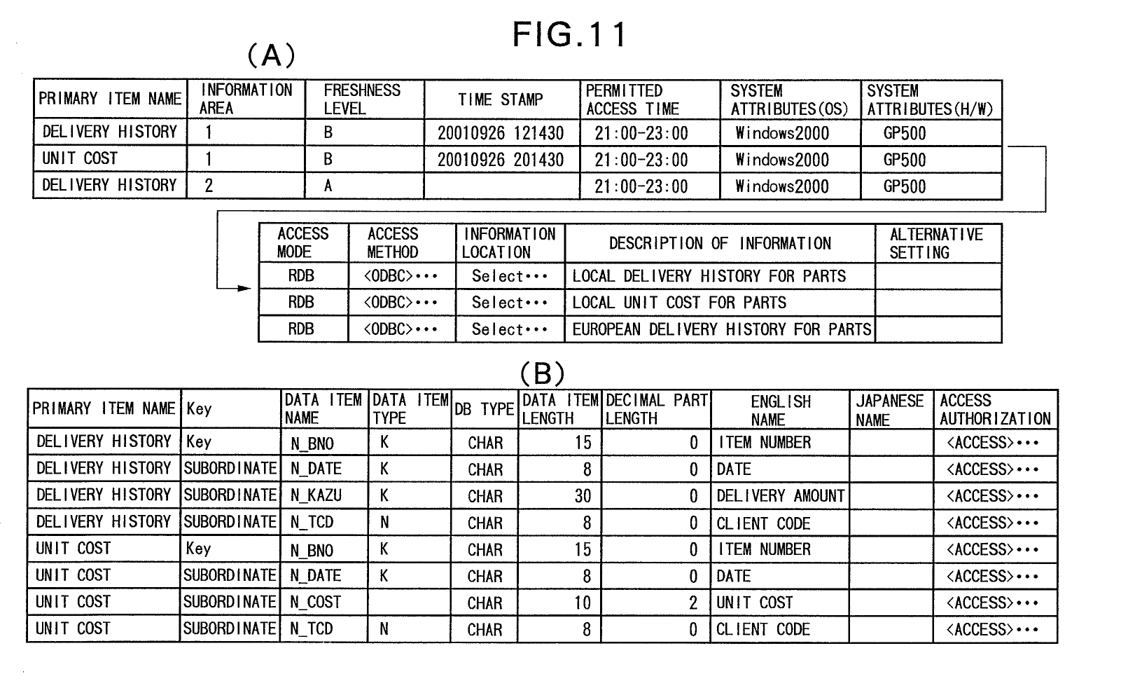

On the other hand, a basic attributes table and a detailed attributes table are set, as information source attributes, in the information source metainformation of the repository 26. As shown in (A) of FIG. 11, basic attributes of the information sources are set in the basic attributes table. For example, primary item name, information area, freshness level, time stamp, permitted access time, system attributes (OS: operating system), system attributes (H/W: hardware), access mode, access method, information location, information description and alternative settings (alternative information) are set. Here, the time and date when copies of master information were made are set in the time stamp except in the case of master information A being the information source. Moreover, at least one access path to similar information is set arbitrarily in the alternative setting so that when an access request to information is made outside the permitted access time, similar information can be collected instead of the requested information.

As shown in (B) of FIG. 11, details of the basic attributes of each information are set in the detailed attributes table. For example, primary item name, key, data item name, data item type, DB type, data item length, length of decimal part, Japanese name and access authorization are set. Here, the access authorization is set to be published, for example, at personal level (1), in a specific department (2), inside a company (3), and in a group enterprise (4). Here, the access authorization can be set freely by using XML (eXtensible Markup Language) and the like.

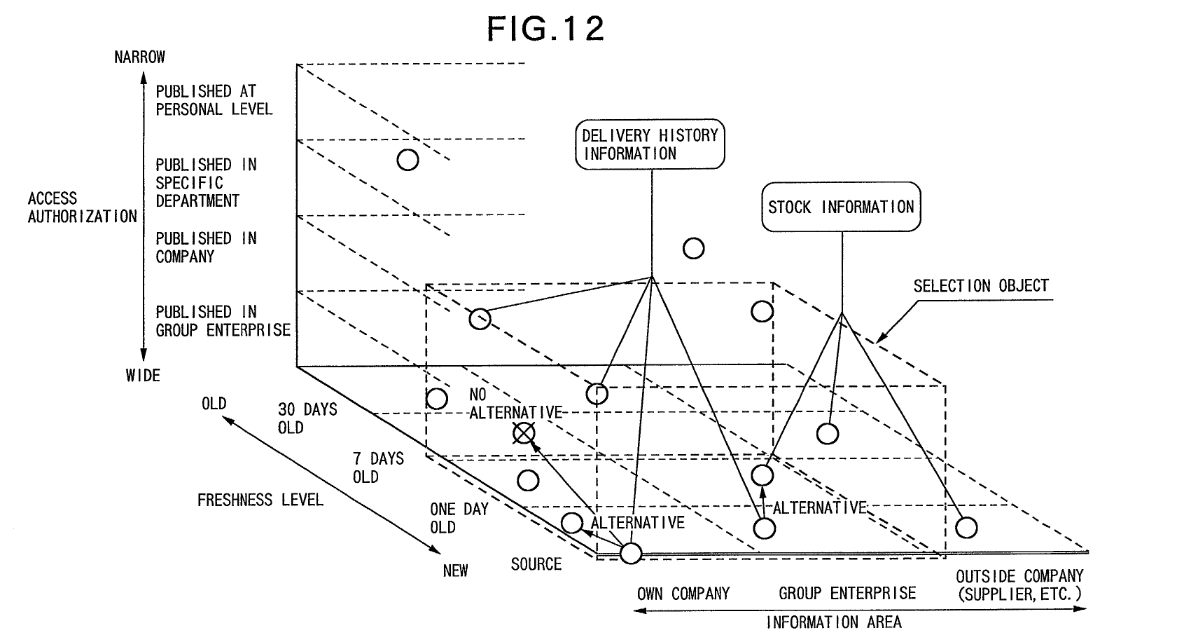

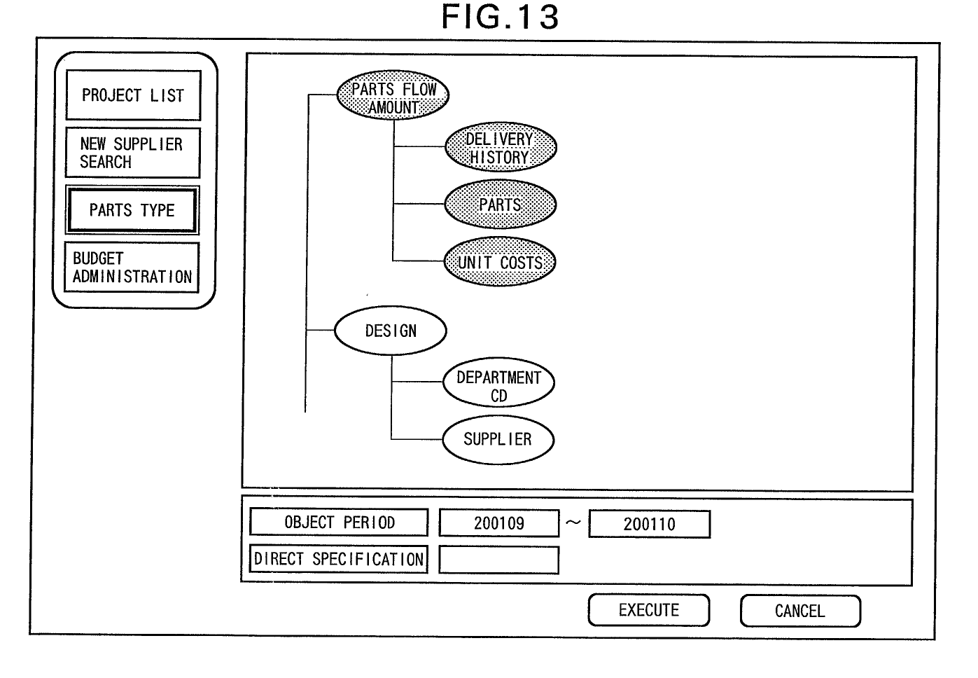

Then, a multi-dimensional map as shown in FIG. 12 is created using the information area, freshness level and access authorization as its attributes. The multi-dimensional map is made up of segments arranged by information area, freshness level and access authorization, each divided into a plurality of divisions, and all information distributed around the plurality of information sources is arranged so as to be enabled to be identified. Here, the master information,being information sources, is all arranged on one plane regardless of the duration from information generation. Furthermore, the copy information is re-arranged on the multi-dimensional map after the freshness level is updated appropriately along with the time elapsed since information generation.

When starting the investigation of parts flow amount, firstly in the client 10, the user ID and password are input as the log-in information to log in. Then, the login information is transmitted to the server 20, and the user metainformation of the employee to be specified by the log-in information is obtained from the repository 26. When the user metainformation is obtained, the relational model related thereto is obtained from the repository 26, and this is transmitted to the client 10. Then, the relational models related to projects charged by the local supply person are displayed in a hierarchical tree structure on the display device of the client 10 as shown in FIG. 13.

When the local supply person presses an “execute” button after specifying parts flow amount from the relational model displayed, the collection execution command is transmitted to the server 20 together with information indicating that parts flow amount has been specified (referred to hereunder as “specified information”). Here, in a case where it is desired to stop collecting information for some reason, if a “cancel” button is pressed at an arbitrary point of time, collection stop information is transmitted to the server 20. Alternatively, in the server 20, which received the specified information and collection execution command, information to be collected is selected based on the specified information, the information area and freshness level set in the user metainformation, and the access authorization set in the information source metainformation. That is to say, the multi-dimensional map is referenced and, as shown in FIG. 12, the information contained in the multi-dimensional region delimited by broken lines is selected.

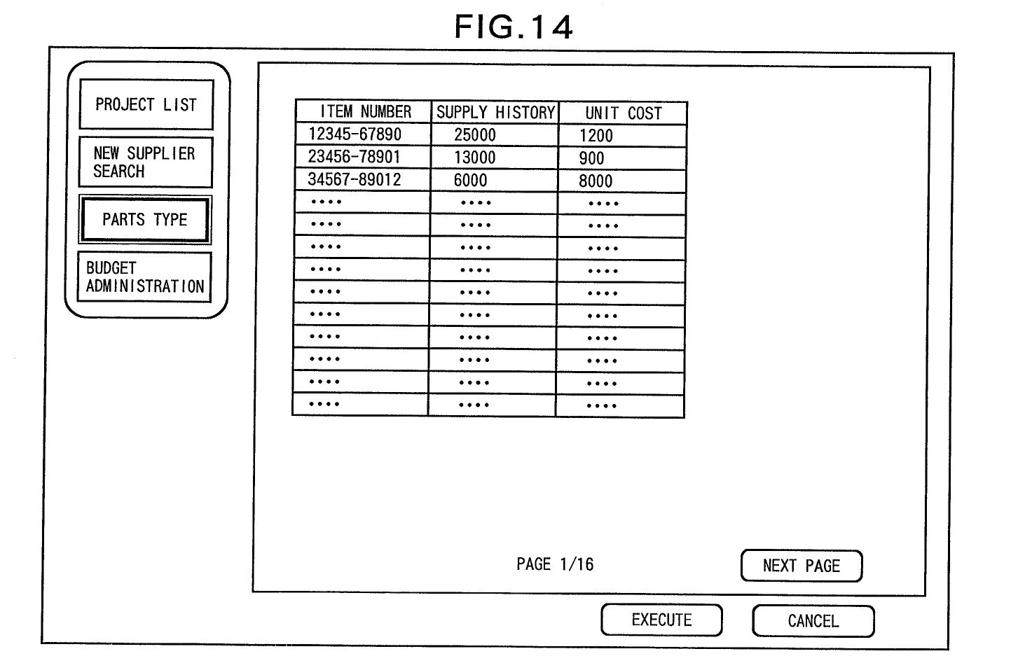

Then, for all information selected, the adaptors appropriate to the access modes set in the information source metainformation are selected automatically, and the information content is collected from the information sources using the access method and information location. At this time, when the information sources are accessed outside a permitted access time and there is an alternative setting in the information source metainformation, the similar information contained in the multi-dimensional region shown by broken lines is collected. Here, a symbol “×” in the figure means that the similar information is outside the multi-dimensional region, so alternation is not possible. Afterwards, the collection information is transmitted to the client 10, and displayed on the display device as shown in FIG. 14.

Here, when information sources are accessed outside a permitted access time, the constitution may be such that messages are displayed, for example, “If you wait for one hour, there are five accessible information sources. Do you want to continue processing?”, “If you wait two hours, you can collect information regarding xxx.” In this manner, if information collecting is requested again after a predetermined time has passed, it is possible to collect only the really required information, so that it is possible to perform the operation efficiently. The function of displaying such messages corresponds to a time display device.

According to the information collecting apparatus described above, by matching the user attributes and information source attributes, it is possible to collect required information speedily and easily from among a large amount of information distributed around the plurality of information sources. At this time, if the repository is appropriately updated automatically or manually, for example, access to obsolete information is prevented, thus enabling an improvement of information collecting efficiency. Furthermore, since it is also possible to collect up-to-date information, it is possible, for example, to perform the operation appropriately and efficiently.

What is claimed is:

1. An information collecting apparatus comprising: a multi-dimensional map in which all information distributed around a plurality of information sources is arranged so as to be enable to be identified according to a plurality of attributes; an information source attributes registration device that is registered with locations of said information sources; an information selection device that selects information contained in a multi-dimensional region delimited arbitrarily by said plurality of attributes referring to said multi-dimensional map; and an information collecting device that collects information from locations of information sources registered in said information source attributes registration device, for all information selected by said information selection device.

2. An information collecting apparatus according to claim 1,
wherein access modes to said information sources are registered in said information source attributes registration device in related to the locations of said information sources, and said information collecting device collects information from said information sources based on access modes registered in said information source attributes registration device.

3. An information collecting apparatus according to claim 1, further comprising; a user attributes registration device that is registered with said multi-dimensional region related to information users,
wherein said information selection device selects information contained in said multi-dimensional region registered in said user attributes registration device.

4. An information collecting apparatus according to claim 1,
wherein alternative information for accessing to similar information when said information source cannot be accessed, is registered in said information source attributes registration device.

5. An information collecting apparatus according to claim 1, further comprising: a relational model display device that displays relational models of said information; and a relational model specifying device that specifies at least one relational model from among the relational models displayed by said relational model display device,
wherein said information selection device selects information contained in said multi-dimensional region from within a range of relational models specified by said relational model specifying device referring to said multi-dimensional map.

6. An information collecting apparatus according to claim 1,
wherein a permitted access time to said information sources is registered in said information source attributes registration device, and there is provided a time display device that displays at least a time to the permitted access time, when it is judged that it is outside the permitted access time to said information sources based on the permitted access time registered in said information source attributes registration device.

7. An information collecting method,
wherein all information distributed around a plurality of information sources is arranged in a multi-dimensional map so as to enable to be identified according to a plurality of attributes thereof, the locations of said information sources are registered, information contained in multi-dimensional regions that are delimited arbitrarily according to said plurality of attributes is selected referring to said multi-dimensional map, and, for all information selected, information is collected from the registered locations of said information sources.

8. An information collecting method according to claim 7,
wherein access modes for said information sources are registered in related to the locations of said information sources, and information is corrected from said information sources based on said registered access modes.

9. An information collecting method according to claim 7,
wherein said multi-dimensional region related to information users is registered, and information contained in said registered multi-dimensional region is selected referring to said multi-dimensional map.

10. An information collecting program for realizing in a computer: an information selection function for selecting, by referring to a multi-dimensional map in which all information distributed around a plurality of information sources is arranged so as to be enable to be identified according to a plurality of attributes, information contained in a multi-dimensional region delimited arbitrarily by said plurality of attributes; and an information collecting function for collecting information from locations of information sources registered in advance for all information selected by said information selection function.

11. An information collecting program according to claim 10,
wherein said information collecting function collects information from said information sources based on access modes for said information sources registered in advance in related to locations of said information sources.

12. An information collecting program according to claim 10,
wherein said information selection function selects information contained in said multi-dimensional region registered in advance in related to information users referring to said multi-dimensional map.
